(19) United States
(12) Patent Application Publication
(10) Pub. No.: US 2009/0126434 A1
(43) Pub. Date: May 21, 2009

(54) PRESS MACHINE, AND METHOD FOR CONTROLLING PRESS MACHINE

(75) Inventor: Takayuki KAWASAKI, Inuyama-shi (JP)

Correspondence Address: GLOBAL IP COUNSELORS, LLP, 1233 20TH STREET, NW, SUITE 700, WASHINGTON, DC, 20036-2680, US

(73) Assignee: Murata Machinery, Ltd., Kyoto-shi (JP)

(21) Appl. No.: 12/263,125

(22) Filed: Oct. 31, 2008

(30) Foreign Application Priority Data
Nov. 19, 2007 (JP) 2007-298841

(51) Int. Cl. B30B 15/14; B30B 1/18; B30B 15/28; B21D 55/00; B21D 24/00

(52) U.S. Cl. 72/20.2; 72/21.4; 72/454; 100/289

(57) ABSTRACT

A press machine in which the service life of a ball thread mechanism is extended. The press machine includes a die 2, a punch 4, a press drive mechanism 6, a height position changing mechanism 21, and a die height position control device 32. The press drive mechanism 6 is configured to move the punch up and down. The press drive mechanism includes at least one ball thread mechanism 10 in which a nut 13 is threaded via balls 12 onto a threaded shaft 11. A rotational drive source 14 is provided to rotate one of the threaded shaft 11 and the nut 13. The position changing mechanism 32 is configured to change the height of the die 2. The die position control device 32 controls the height of the die 2 via the position changing mechanism 21 so that the position varies where the balls 12 come into contact with the inner face of the thread grooves 11a of the threaded shaft 11 during pressing.

### CROSS-REFERENCE TO RELATED APPLICATIONS

This application claims priority under 35 U.S.C. §119 to Japanese Patent Application No. 2007-298841 filed on Nov. 19, 2007. The entire disclosure of Japanese Patent Application No. 2007-298841 is hereby incorporated herein by reference.

### BACKGROUND OF THE INVENTION

1. Field of the Invention

The present invention relates to a press machine for performing press working of a sheet material, such as a press brake or a punch press, and to a method for controlling this press machine.

2. Background Information

A typical press brake has a die (serving as the stationary-side pressing tool) and a punch (the movable-side pressing tool) provided one above the other. A sheet material that is to be worked is placed in between the two pressing tools, and the punch is pressed against the die with the sheet material in between, which bends the sheet material in a V shape. A ball thread mechanism, for example, is used for the press drive mechanism that drives the punch up and down. Related technology has been disclosed in Japanese Laid-Open Utility Model Application S63-19919 and Japanese Patents 3405930 and 2764350.

With the above-mentioned press brake, the press drive mechanism is subjected to a tremendous bending load at the final bending stage of the sheet material, that is, when the punch is located at bottom dead center of the stroke. When a ball thread mechanism is used for the press drive mechanism, the above-mentioned bending load is applied via the balls to the inner face of the thread grooves of a threaded shaft in the ball thread mechanism. In actual working, bending is usually continued at the same or about the same bending angle on sheet material of the same or about the same thickness. Therefore, under the maximum bending load the balls always come into contact with substantially the same places on the inner face of the thread grooves of the threaded shaft, and abrasion and so forth result in partial wear at these places, which ends up shortening the service life of the ball thread mechanism.

### SUMMARY OF THE INVENTION

One aspect of the present invention is to extend the service life of the ball thread mechanism used to raise and lower the movable-side pressing tool in the press machine by providing a mechanism that has a simple configuration.

According to another aspect of the present invention includes a stationary-side pressing tool whose position is stationary during working, a movable-side pressing tool, a press drive mechanism for moving the movable-side pressing tool up and down with respect to the stationary-side pressing tool, a height position changing mechanism for changing the height position of the stationary-side pressing tool with respect to a frame on which the stationary-side pressing tool is installed, and a height position control device for controlling the height position changing mechanism. The press drive mechanism includes a ball thread mechanism in which a nut is threaded via a plurality of balls onto a threaded shaft that is oriented vertically, and a rotational drive source for rotating one of the threaded shaft and the nut. The movable-side pressing tool and the other of the threaded shaft and the nut are linked so as to operate integrally. The height position control device performs control the height position mechanism so that the position varies where the balls come into contact with the inner face of the thread grooves of the threaded shaft when the movable-side pressing tool comes into contact with a workpiece and a pressing load is exerted.

With this constitution, the height position changing mechanism is controlled by the height position control device, and the height position of the movable-side pressing tool is changed so that the position varies where the balls come into contact with the inner face of the thread grooves of the threaded shaft when the movable-side pressing tool comes into contact with a workpiece and a pressing load is exerted. The result of varying the position where the balls come into contact with the inner face of the thread grooves of the threaded shaft is that it avoids the concentration of load at the same place on the inner face of the thread grooves of the threaded shaft. This prevents wear from proceeding locally due to abrasion and so forth of the threaded shaft, and extends the service life of the ball thread mechanism. The timing at which the height position of the stationary-side pressing tool is changed may, for example, be when a specific number of working iterations has been reached, or when a specific working time has elapsed. The above-mentioned specific number of iterations or specific time can be changed as desired.

According to another aspect of the present invention, the range over which the height position of the stationary-side pressing tool is varied by the height position control device with the height position changing mechanism is not more than the length in the threaded shaft axial direction of the layout pitch of the balls interposed between the threaded shaft and the nut.

According to still another aspect of the present invention, the press machine further comprises a drive amount changing component for changing the amount of drive applied to the movable-side pressing tool according to how much the height position of the stationary-side pressing tool is changed.

According to yet another aspect of the present invention, the drive amount changing component changes the amount of drive applied to the movable-side pressing tool so that the distance between the stationary-side pressing tool and the movable-side pressing tool when the movable-side pressing tool is located at bottom dead center of the stroke will be the same before and after changing the height position of the movable-side pressing tool.

According to a further another aspect of the present invention, the stationary-side pressing tool is a die disposed on the lower side of a sheet material serving as the workpiece, the movable-side pressing tool is a punch disposed on the upper side of the sheet material, and the combined movement of the die and punch constitutes a press brake that bends the sheet material into a V shape.

These features, aspects and advantages of the present invention will become apparent to those skilled in the art from the following detailed description, which, taken in conjunction with the annexed drawings, disclosed in the example embodiments of the present invention.

### BRIEF DESCRIPTION OF THE DRAWINGS

Referring now to the attached drawings which form a part of this original disclosure:

FIG. 1 is a front view of the press machine pertaining to an embodiment of the present invention;

FIG. 2 is a side view of this press machine;

FIG. 3 is a cross section of part of the ball thread mechanism of this press machine;

FIG. 4 is a detail enlargement of FIG. 3;

FIG. 5 is a front view illustrating the simplified configuration of this press machine;

FIG. 6 is a side view illustrating the simplified configuration of this press machine; and

FIG. 7 is a block diagram of the control system of this press machine.

### DETAILED DESCRIPTION OF THE EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Configuration of Press Machine

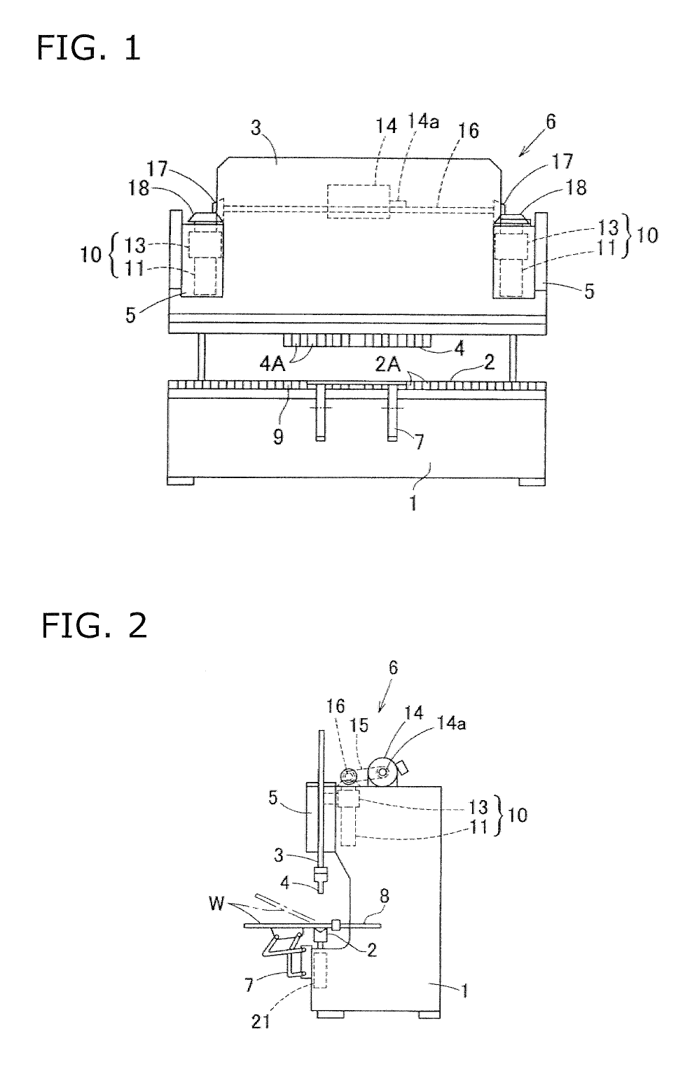

Referring initially to FIG. 1, a press machine is illustrated in accordance with an embodiment of the present invention, and FIG. 2 is a side view thereof. The press machine is a press brake, in which a linear die 2 serving as the stationary-side pressing tool is attached to a frame constituting a bed 1, and a punch 4 serving as the movable-side pressing tool is attached to the lower end of a ram 3. The ram 3 is disposed on the bed 1 and movable in the vertical direction by way of guides 5 on the left and right sides and is driven up and down by a press drive mechanism 6.

The die 2 and the punch 4 are divided into a plurality of tool segments 2A and 4A in the tool width direction, and the tool width can be changed by selecting the number and layout of the tool segments 2A and 4A. This changing of the tool width is carried out by moving the tool segments 2A and 4A between their usage position during working (the depicted position) and their retracted position by means of a tool segment selection mechanism (not shown).

A sheet material support base 7 and a gauge 8 are installed on the bed 1 in front of and behind the die 2. The sheet material W to be bent (the workpiece) is placed on the sheet material support base 7 and inserted into the die 2 until hitting the gauge 8. The sheet material W is sandwiched between the die 2 and the punch 4 as the ram 3 lowers the punch 4, so that the sheet material W is bent into a V shape.

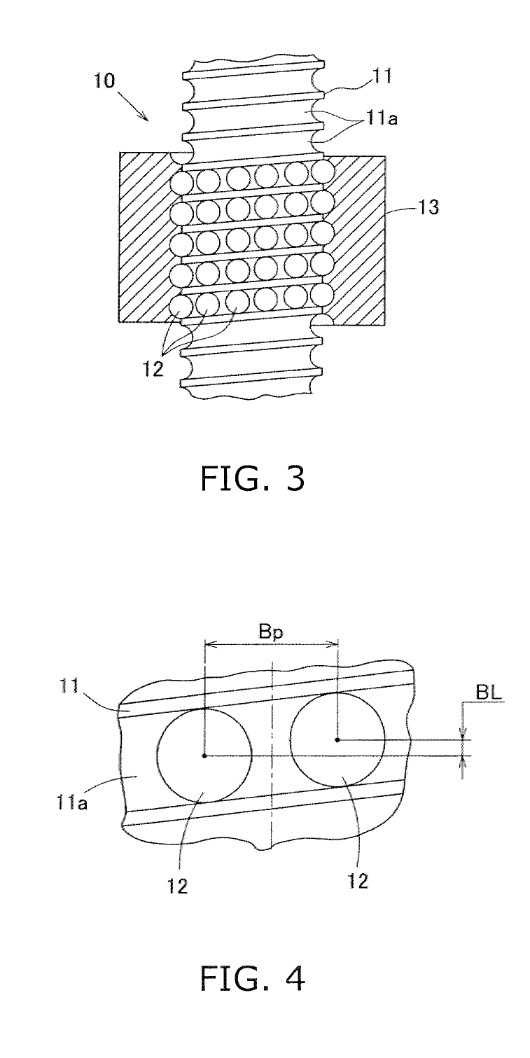

The press drive mechanism 6 has a pair of left and right ball thread mechanisms 10 provided aligned with the left and right guides 5. As shown in FIGS. 3 and 4, the ball thread mechanisms 10 each comprise a threaded shaft 11 that is oriented vertically, and a nut 13 that threads onto this threaded shaft 11 via balls 12. The nut 13 is provided with an end cap, a return tube, a stem member, or another such circulation mechanism (not shown) that allows the balls 12 to circulate between the threaded shaft 11 and the nut 13. The threaded shaft 11 of each ball thread mechanism 10 is selectively rotated in the forward and reverse directions by a common rotational drive source 14. The rotational drive source 14 is a servo motor, for example. The rotation of the rotational drive source 14 is transmitted by a chain transmission device 15 from an output shaft 14a to a rotation transmission shaft 16, and then from the rotation transmission shaft 16 via bevel gears 17 and 18 to the threaded shaft 11. The nut 13 is operatively engaged with the ram 3 and moves integrally with the punch 4. As shown in FIG. 6, the die 2 has a V-groove 2a in its upper face, and the lower end of the punch 4 has a shape corresponding to the V-groove 2a.

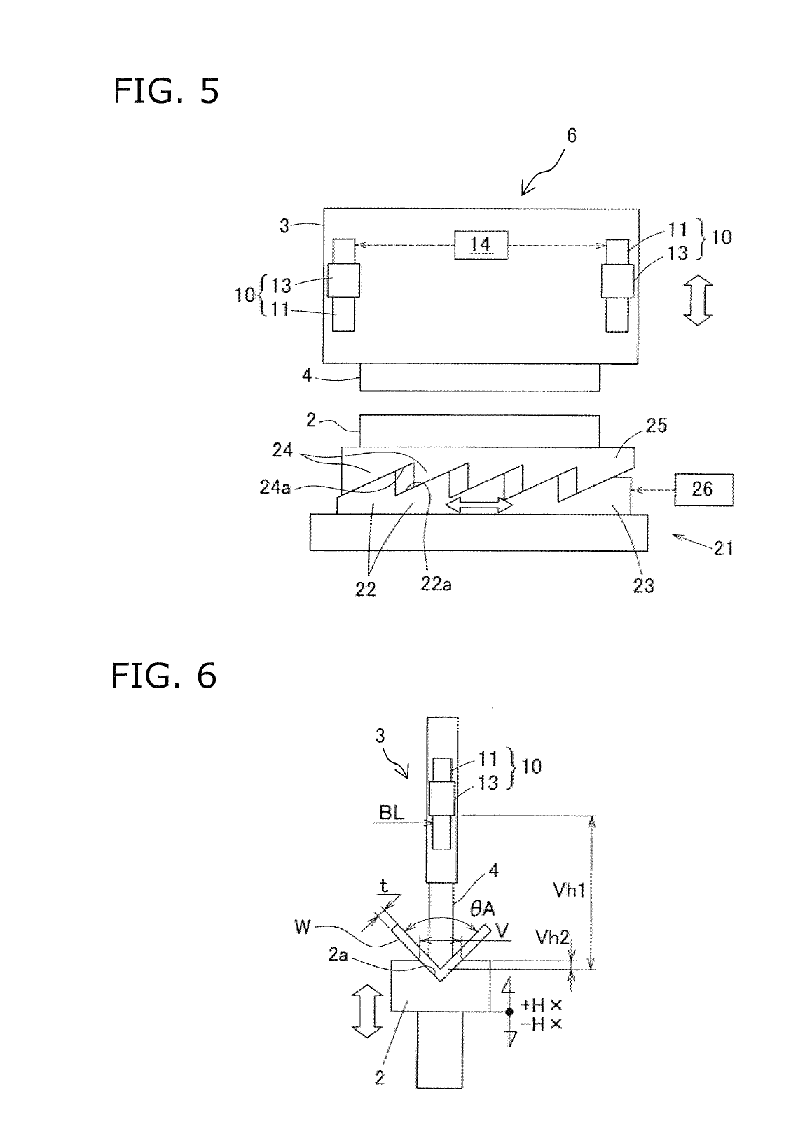

The bed 1 is provided with a height position changing mechanism 21 for changing the height position of the die 2. As shown in FIGS. 5 and 6, which illustrate the simplified configuration of a press brake, the height position changing mechanism 21 comprises a slider 23 and an elevator 25. The slider 23 has a plurality of lower wedges 22 whose upper faces are formed as sloped faces 22a of a specific angle. The elevator 25 is arranged to support the tool segments 2A of the die 2. The elevator 25 can move up and down and has on its lower face a plurality of upper wedges 24 formed as sloped faces 24a of the same angle as that of the sloped faces 22a of the lower wedges 22 of the slider 23.

The slider 23 is moved horizontally with respect to the bed 1 by a drive source 26. The drive source 26 is a servo motor, for example, and the rotation of the drive source 26 is converted into linear motion by a rotation/linear conversion mechanism (not shown) such as a rack and pinion mechanism. In FIG. 5, the slope of faces 22a and 24a is exaggerated for illustration purposes. The actual slope of faces 22a and 24a is less than that shown in the drawing.

Press Brake Control Device

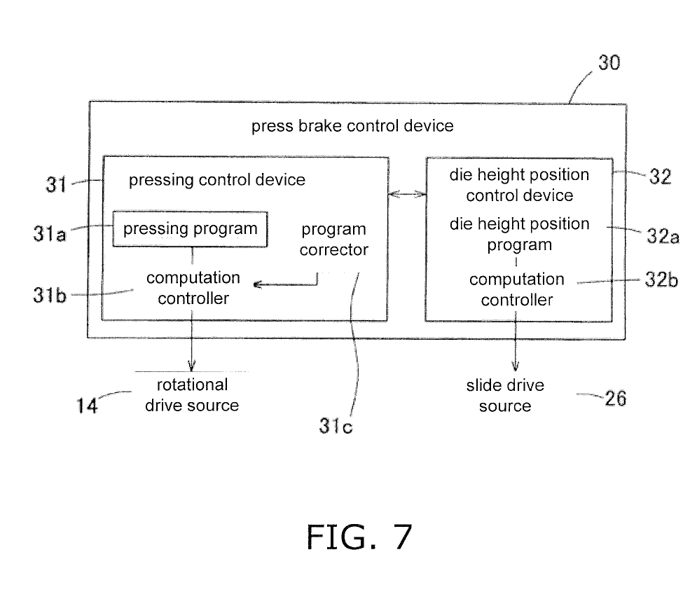

Referring now to FIG. 7, a press brake control device 30 for controlling the press machine will be described. The press brake control device 30 comprises a pressing control device 31 and a die height position control device 32. The pressing control device 31 is configured to control pressing, and the die height position control device 32 is configured to control the height position of the die 2. The pressing control device 31 includes a computer-type numerical value control device and a programmable controller. The pressing control device 31 also includes a pressing program 31a, a computation controller 31b, and a program corrector 31c. The computation controller 31b is configured to execute the pressing program 31a. The program corrector 31c is configured to correct the commands of the pressing program 31a according to changes to the height position of the die 2.

The program corrector 31c is either provided as part of the computation controller 31b or separately from the computation controller 31b. The die height position control device 32 includes a programmable controller, a die height position control program 32a, and a computation controller 32b. The computation controller 32b is configured for executing the die height position control program 32a. The computation controllers 31b and 32b encompass those, for example, that include the programmable controller, a central processing unit, a memory, etc. The computation controller 32b of the die height position control device 32 may share all or part of the programmable controller, etc., of the computation controller 31b of the pressing control device 31.

Control Operation

The computation controller 31b of the pressing control device 31 outputs a drive command to the rotational drive source 14 to operate the pair of left and right ball thread mechanisms 10. Every time the computation controller 31b of the pressing control device 31 outputs a drive command, a signal indicating the number of pressing iterations is sent from the pressing control device 31 to the die height position control device 32. The die height position control device 32 counts these signals, and when the count reaches a specific number, the computation controller 32b of the die height position control device 32 outputs a drive command to the drive source 26 for operating the height position changing mechanism 21.

The output to the drive source 26 satisfies the relationship 0≦±Hx≦BL, where Hx is the height position change amount of the die 2, and BL (FIG. 4) is the threaded shaft axial length of the layout pitch Bp (FIG. 4) of the balls 12 in the ball thread mechanisms 10. Specifically, the height position of the die 2 is changed within a range of the layout pitch Bp of the balls 12 that is less than the threaded shaft axial length BL. As a result, the position varies where the balls 12 come into contact with the inner face of the thread grooves 11a of the threaded shaft 11 under maximum bending load. Also, when the position where these balls 12 come into contact is displaced a plurality of times, this position is controlled by the die height position control device 32 so as to be averaged over the range of the layout pitch Bp of the balls 12.

The punch elevation command of the pressing program 31a is corrected by the program corrector 31 c according to the height position change of the die 2 when the command is executed such that the distance between the die 2 and the punch 4 when the punch 4 is at bottom dead center of the stroke is the same before and after the change to the height position of the die 2. More specifically, the drive amount Vh1 of the punch 4 is changed. Thus, the program corrector 31c functions as a drive amount changing component.

The reason for changing the drive amount Vh1 of the punch 4 and the height position of the die 2 as discussed above will now be explained. In general, the target bending angle θA of the sheet material W is determined by the groove width V of the die 2 and the thickness t of the sheet material W. Accordingly, when bending is performed under a given set of conditions, the drive amount Vh1 of the punch 4 is constant. Under the maximum bending load, the balls 12 always come into contact with substantially the same places on the inner face of the thread grooves 11a, and wear of the threaded shaft 11 proceeds locally. To prevent this, the positions where the balls 12 come into contact with the inner face of the thread grooves 11a should be dispersed in the direction of the thread grooves 11a. Under maximum bending load, that is, when the punch 4 is in contact with the sheet material W and a pressing load is being exerted, the position varies where the balls 12 come into contact with the inner face of the thread grooves 11a of the threaded shaft 11 by changing the height position of the die 2 and the drive amount Vh1 of the punch 4. This avoids the concentration of bending load at the same place on the thread grooves 11a. Since wear of the threaded shaft 11 is prevented from proceeding locally, this extends the service life of the ball thread mechanisms 10.

Since the positions where the balls 12 hits within the range of the layout pitch Bp of the balls 12 should be dispersed, the amount of change to the height position of the die 2 is sufficient as long as it is at most the length BL in the threaded shaft axial direction of the layout pitch Bp of the balls 12. If the amount of change to the height position of the die 2 is set to within a range that is not more than the length BL in the threaded shaft axial direction of the layout pitch Bp of the balls 12, which is the minimum required distance, the height position changing mechanism 21 can be compact and simple in its construction. When the position is varied a plurality of times where the balls 12 come into contact with the inner face of the thread grooves 11a of the threaded shaft 11 when the punch 4 is in contact with the sheet material W and a pressing load is being exerted, then as long as this position is controlled so as to be averaged over the range of the layout pitch BP of the balls 12, wear to the inner face of the thread grooves 11a of the threaded shaft 11 will proceed uniformly, so the service life of the ball thread mechanisms 10 can be extended to its maximum.

Features

The press machine comprises the die 2 whose position is stationary during working, the punch 4, the press drive mechanism 6 that moves the punch 4 up and down with respect to the die 2, the height position changing mechanism 21 that changes the height position of the die 2 with respect to a frame on which the punch 4 is installed, and the die height position control device 32 that controls the height position changing mechanism 21. The press drive mechanism 6 has ball thread mechanisms 10 in which the nut 13 is threaded via the balls 12 onto the threaded shaft 11 that is oriented vertically, and the rotational drive source 14 for rotating one of the threaded shaft 11 and the nut 13. The punch 4 and the other of the threaded shaft 11 and the nut 13 are linked so as to operate integrally. The die height position control device 32 performs control such that the height position of the die 2 is changed by the die height position changing mechanism 21 so that the position varies where the balls 12 come into contact with the inner face of the thread grooves 11a of the threaded shaft 11 when the punch 4 comes into contact with a workpiece and a pressing load is exerted.

This configuration avoids the concentration of load at the same place on the inner face of the thread grooves 11a of the threaded shaft 11. This prevents wear from proceeding locally due to abrasion and so forth of the threaded shaft 11, and extends the service life of the ball thread mechanisms 10. The timing at which the height position of the die 2 is changed may, for example, be when a specific number of working iterations has been reached, or when a specific working time has elapsed. The above-mentioned specific number of iterations or specific time can be changed as desired.

With this embodiment, the press machine to which the present invention is applied has the die 2 disposed on the lower side of the sheet material serving as the workpiece, and the punch 4 disposed on the upper side of the sheet material, the combined movement of the die 2 and punch 4 constitutes a press brake that bends the sheet material into a V shape, and the press drive mechanism 6 comprises a plurality of the ball thread mechanisms 10 arranged in rows.

With a press brake, the bending load is concentrated in the press drive mechanism at the final bending stage of the sheet material, so in the case of this embodiment, in which the ball thread mechanisms 10 are used for the press drive mechanism 6, the bending load tends to be exerted at the same place on the inner face of the thread grooves 11a of the threaded shaft 11 in the ball thread mechanisms 10. Therefore, changing the height position of the die 2 with the height position changing mechanism 21 has a tremendous effect.

Also, since the press drive mechanism 6 comprises a plurality of the ball thread mechanisms 10 arranged in rows, the effect of applying this invention is even more pronounced. Specifically, when the threaded shaft 11 is replaced with a new one due to wear of the threaded shaft 11 caused by bending load, this entails adjustment of the entire machine, so the work is not easy, and furthermore the operation of the machine has to be halted during this procedure. This adjustment is particularly difficult when a plurality of the ball thread mechanisms 10 are arranged in rows. However, with the press brake pertaining to the present invention, the service life of the ball thread mechanisms 10 is greatly extended, which means the ball thread mechanisms 10 have to be replaced, and the entire machine adjusted, less frequently.

The height position changing mechanism 21 is configured such that it changes the height position of the frame of the bed 1 on which is installed the die 2, which does not move up or down during pressing, so the height position changing mechanism can be simpler in terms of both structure and control than when changing the height position of a frame on which is installed a movable-side pressing tool that moves up and down during pressing.

### Other Example Embodiments

In the above embodiment, the height position of the die 2 was changed when a specific number of working iterations was reached, but the height position of the die 2 may instead be changed when another condition that affects the wear of the threaded shaft 11 has been satisfied, such as when a specific working time has elapsed.

Also, the ball thread mechanisms 10 were configured such that the nut 13 was stationary and the threaded shaft 11 was rotated, but the configuration may be reversed so that the threaded shaft 11 is stationary and the nut 13 is rotated.

This invention can also be applied to other press machines, e.g. a punch press.

As used herein, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A press machine, comprising:
a stationary-side pressing tool whose position is stationary during working;
a movable-side pressing tool;
a press drive mechanism configured to move the movable-side pressing tool up and down with respect to the stationary-side pressing tool, the press drive mechanism including a ball thread mechanism in which a nut is threaded via a plurality of balls onto a threaded shaft that is oriented vertically, and a rotational drive source for rotating one of the threaded shaft and the nut;
a height position changing mechanism configured to change the height position of the stationary-side pressing tool with respect to a frame on which the stationary-side pressing tool is installed; and
a height position control device configured to control the height position changing mechanism such that the height position of the stationary-side pressing tool is changed so that the position varies where the balls come into contact with the inner face of the thread grooves of the threaded shaft and when the movable-side pressing tool comes into contact with a workpiece and a pressing load is exerted,
wherein the movable-side pressing tool and the other of the threaded shaft and the nut are operatively linked together.

2. The press machine according to claim 1, wherein
the range over which the height position of the stationary-side pressing tool is varied by the height position control device with the height position changing mechanism is not more than the length in the threaded shaft axial direction of the layout pitch of the balls interposed between the threaded shaft and the nut.

3. The press machine according to claim 1, further comprising
a drive amount changing component configured to change the amount of drive applied to the movable-side pressing tool according to how much the height position of the stationary-side pressing tool is changed.

4. The press machine according to claim 2, further comprising
a drive amount changing component configured to change the amount of drive applied to the movable-side pressing tool according to how much the height position of the stationary-side pressing tool is changed.

5. The press machine according to claim 3, wherein
the drive amount changing component changes the amount of drive applied to the movable-side pressing tool so that the distance between the stationary-side pressing tool and the movable-side pressing tool, when the movable-side pressing tool is located at the bottom dead center of the stroke, will be the same before and after changing the height position of the movable-side pressing tool.

6. The press machine according to claim 4, wherein
the drive amount changing component changes the amount of drive applied to the movable-side pressing tool so that the distance between the stationary-side pressing tool and the movable-side pressing tool, when the movable-side pressing tool is located at the bottom dead center of the stroke, will be the same before and after changing the height position of the movable-side pressing tool.

7. The press machine according to claim 1, wherein
the stationary-side pressing tool is a die disposed on the lower side of a sheet material serving as the workpiece,
the movable-side pressing tool is a punch disposed on the upper side of the sheet material,
the combined movement of the die and punch constitutes a press brake that bends the sheet material into a V shape, and
the press drive mechanism further includes a plurality of the ball thread mechanisms arranged in rows.

8. The press machine according to claim 2, wherein
the stationary-side pressing tool is a die disposed on the lower side of a sheet material serving as the workpiece,
the movable-side pressing tool is a punch disposed on the upper side of the sheet material,
the combined movement of the die and punch constitutes a press brake that bends the sheet material into a V shape, and
the press drive mechanism further includes a plurality of the ball thread mechanisms arranged in rows.

9. The press machine according to claim 3, wherein
the stationary-side pressing tool is a die disposed on the lower side of a sheet material serving as the workpiece,
the movable-side pressing tool is a punch disposed on the upper side of the sheet material,
the combined movement of the die and punch constitutes a press brake that bends the sheet material into a V shape, and
the press drive mechanism further includes a plurality of the ball thread mechanisms arranged in rows.

10. The press machine according to claim 4, wherein
the stationary-side pressing tool is a die disposed on the lower side of a sheet material serving as the workpiece,
the movable-side pressing tool is a punch disposed on the upper side of the sheet material,
the combined movement of the die and punch constitutes a press brake that bends the sheet material into a V shape, and
the press drive mechanism further includes a plurality of the ball thread mechanisms arranged in rows.

11. The press machine according to claim 5, wherein
the stationary-side pressing tool is a die disposed on the lower side of a sheet material serving as the workpiece,
the movable-side pressing tool is a punch disposed on the upper side of the sheet material,
the combined movement of the die and punch constitutes a press brake that bends the sheet material into a V shape, and
the press drive mechanism further includes a plurality of the ball thread mechanisms arranged in rows.

12. The press machine according to claim 6, wherein
the stationary-side pressing tool is a die disposed on the lower side of a sheet material serving as the workpiece,
the movable-side pressing tool is a punch disposed on the upper side of the sheet material,
the combined movement of the die and punch constitutes a press brake that bends the sheet material into a V shape, and
the press drive mechanism further includes a plurality of the ball thread mechanisms arranged in rows.

13. A method of controlling a press machine that includes a stationary-side pressing tool whose position is stationary during working, a movable-side pressing tool, and a press drive mechanism for moving the movable-side pressing tool up and down with respect to the stationary-side pressing tool, the press drive mechanism has a ball thread mechanism in which a nut is threaded via a plurality of balls onto a threaded shaft that is oriented vertically, and a rotational drive source for rotating one of the threaded shaft and the nut, the movable-side pressing tool and the other of the threaded shaft and the nut being are operatively linked together, the method comprising:
changing the height position of the stationary-side pressing tool so that the position varies where the balls come into contact with the inner face of the thread grooves of the threaded shaft when the movable-side pressing tool comes into contact with a workpiece and a pressing load is exerted.

14. The method according to claim 13, wherein
the range over which the height position of the stationary-side pressing tool is varied is not more than the length in the threaded shaft axial direction of the layout pitch of the balls interposed between the threaded shaft and the nut.

15. The method according to claim 13, further comprising
changing the amount of drive applied to the movable-side pressing tool according to how much the height position of the stationary-side pressing tool is changed.

16. The method according to claim 14, further comprising
changing the amount of drive applied to the movable-side pressing tool according to how much the height position of the stationary-side pressing tool is changed.

17. The method according to claim 15, wherein the changing the amount of drive applied to the movable-side pressing tool includes maintaining the same distance between the stationary-side pressing tool and the movable-side pressing tool, when the movable-side pressing tool is located at the bottom dead center of the stroke, before and after the changing the height position of the movable-side pressing tool.

18. The method according to claim 16, wherein the changing the amount of drive applied to the movable-side pressing tool includes maintaining the same distance between the stationary-side pressing tool and the movable-side pressing tool, when the movable-side pressing tool is located at the bottom dead center of the stroke, before and after the changing the height position of the movable-side pressing tool.
